(19) United States
(12) Patent Application Publication
(10) Pub. No.: US 2011/0139948 A1
(43) Pub. Date: Jun. 16, 2011

(54) Cup holder

(75) Inventor: Peter W.A. Bergin, Rancho Mirage, CA (US)

(73) Assignee: Caddy Products, Inc., palm Dessert, CA (US)

(21) Appl. No.: 12/638,264

(22) Filed: Dec. 15, 2009

(51) Int. Cl. F16M 13/00

(52) U.S. Cl. 248/205.1

(57) ABSTRACT

A cup holder is provided for installation at a juncture of two adjacent seat backs, wherein each of the seat backs has an arcuate back surface having a most rearward point, an intersection of the most rearward points of the two adjacent seat backs defining a plane. The cup holder includes a main body and an attachment portion. The main body includes a receptacle for holding a beverage container and has an installed depth dimension. The installed depth dimension is within a space defined by the adjacent seat backs and the plane. The attachment portion attaches the main body at the juncture of the two adjacent seat backs.

### FIELD OF THE INVENTION

The present invention relates to a cup holder that is utilized in stadium, arena and theater seating. More particularly, the present invention relates to a cup holder that attaches to a seat back or adjacent seat backs and yet allows compact storage of bleacher-style seats.

### BACKGROUND OF THE INVENTION

Cup holders are utilized venues such as theaters, arenas and stadiums to provide event-goers with convenient places to stow their liquid beverages. Cup holders may be positioned proximate a front end of a seat standard (support frame) or arm. Cup holders may also be secured to a back end of a standard as well as to the back surface of the seat back.

Because such venues may serve more than one purpose or have varying capacity requirements, some of the seating may be collapsible and/or removable to allow for different seating configurations. Typically, the movable seating has a telescoping bleacher-type construction, where one seat row fits underneath another seat row in a vertically stacked configuration. This generally requires a seat back to be positioned in a substantially horizontal position. When the seat backs are collapsed forward to lie horizontally, the cup holders attached to the seat backs tend to prevent the proper stacking of rows of seats in a stored position.

### SUMMARY OF THE INVENTION

The disclosure is directed to a cup holder for installation at a juncture of two adjacent seat backs, wherein each of the seat backs has an arcuate back surface having a most rearward point, an intersection of the most rearward points of the two adjacent seat backs defining a plane. The cup holder comprises a main body and an attachment portion. The main body comprises a receptacle for holding a beverage container and has an installed depth dimension. The installed depth dimension is within a space defined by the adjacent seat backs and the plane. The attachment portion attaches the main body at the juncture of the two adjacent seat backs.

This Summary is provided to introduce concepts in simplified form that are further described below in the Detailed Description. This Summary is not intended to identify key features or essential features of the disclosed or claimed subject matter, is not intended to describe each disclosed embodiment or every implementation of the disclosed or claimed subject matter, and is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1 is a top view of an exemplary embodiment of a cup holder attached to adjacent seat backs.

FIG. 2 is a front perspective view of the cup holder of FIG. 1.

FIG. 3 is a rear perspective view of the cup holder of FIG. 1.

FIG. 4 is a front perspective view of the cup holder of FIG. 1 attached to adjacent seat backs.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. Moreover, where terms such as front, back, in front of, behind, above, below, over, under, top, bottom, side, right, left, etc., are used, it is to be understood that they are used only for ease of understanding the description. It is contemplated that structures may be otherwise oriented.

### DETAILED DESCRIPTION OF ILLUSTRATIVE EMBODIMENTS

The present invention relates to a cup holder for attaching to a back surface of one or more seat backs. The cup holder is mounted on the seat backs so that they are accessible and useable for persons seated in the row behind the row of seats on which the cup holder is mounted.

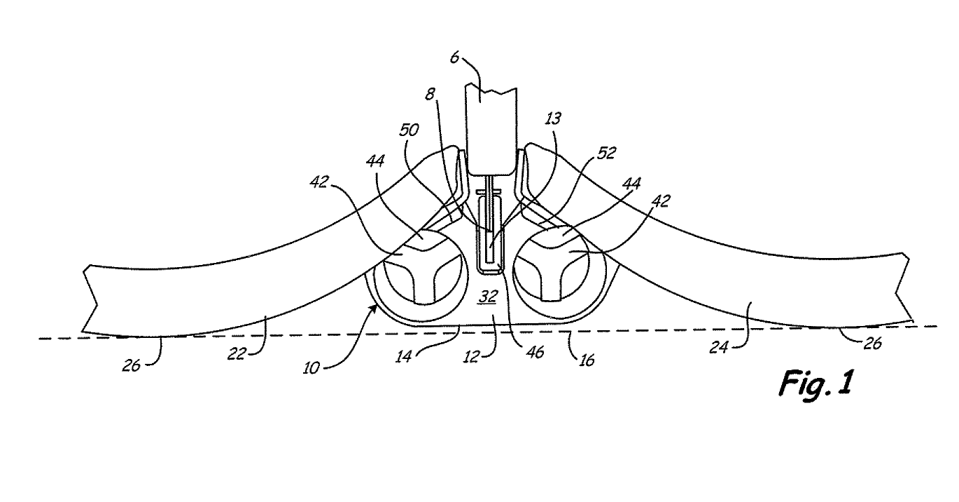

FIG. 1 is a top view of the cup holder 10 for installation at a juncture of two adjacent seat backs 22, 24. In the particular configuration of seats shown, armrest 6 extends between the two seat backs 22, 24. Armrest 6 is pivotally connected to arm standard 13, which forms a part of the seat frame, at pivot point 8. Arm standard 13 typically extends behind the back rest surfaces of seat backs 22, 24 so that when armrest 6 is pivoted up between the seat backs 22, 24, it is then out of the way of the occupants of the seats. However, such a seat construction has required typical cup holders that attach to the seat backs to extend quite far behind seat backs 22, 24, therefore interfering with the stacking of rows of seats when seat backs 22, 24 are flipped forward to a horizontal orientation. Such cup holders contact the horizontal bleacher platform that supports the adjacent upper row of seats and thereby prevent the rows of seats from stacking properly. Moreover, such typical cup holders can be a tripping hazard because they constrict the walkway space between rows of seats.

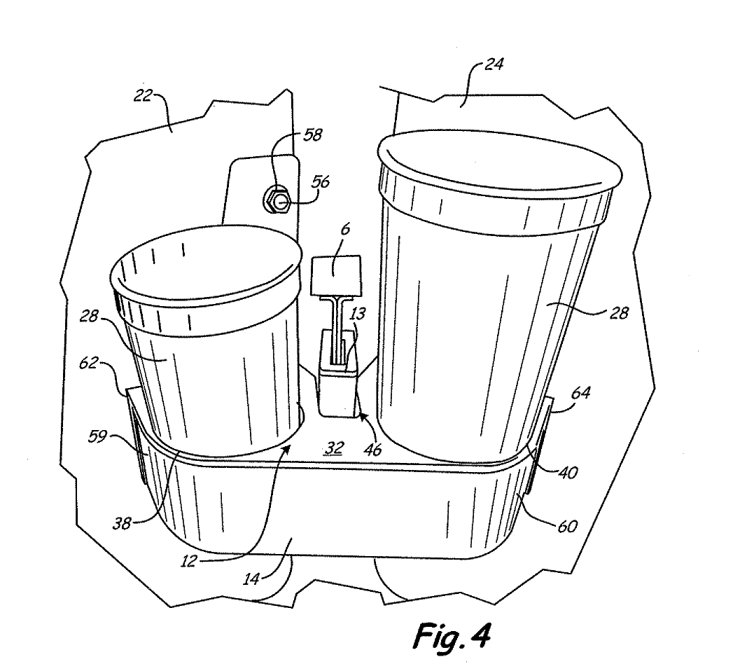

The disclosed cup holder 10 includes a main body 12 having a front wall 14 that is positioned behind a vertical plane 16. In the illustrated embodiment, the installed depth dimension of cup holder 10 fits within a space defined by the adjacent seat backs 23, 24 and plane 16. The plane 16 is defined by intersecting the most rearward points 26 of the back surfaces of two adjacent seat backs 22, 24. With the front wall 14 positioned behind the plane 16, the configuration of the cup holder 10 allows for proper stacking when seat backs 22, 24 are flipped forward to a substantially horizontal storage position. Thus, rows of seats can be stored compactly in a substantially vertical stack by utilizing a telescoping bleacher-type structure. The cup holder 10 provides for a convenient place to position a beverage container 28 (shown in FIG. 4) while not interfering with compact stowage of bleacher style seating. Also, because the front wall 14 is behind the plane 16, the walkway between two rows of seats is not constricted by the cup holder 10.

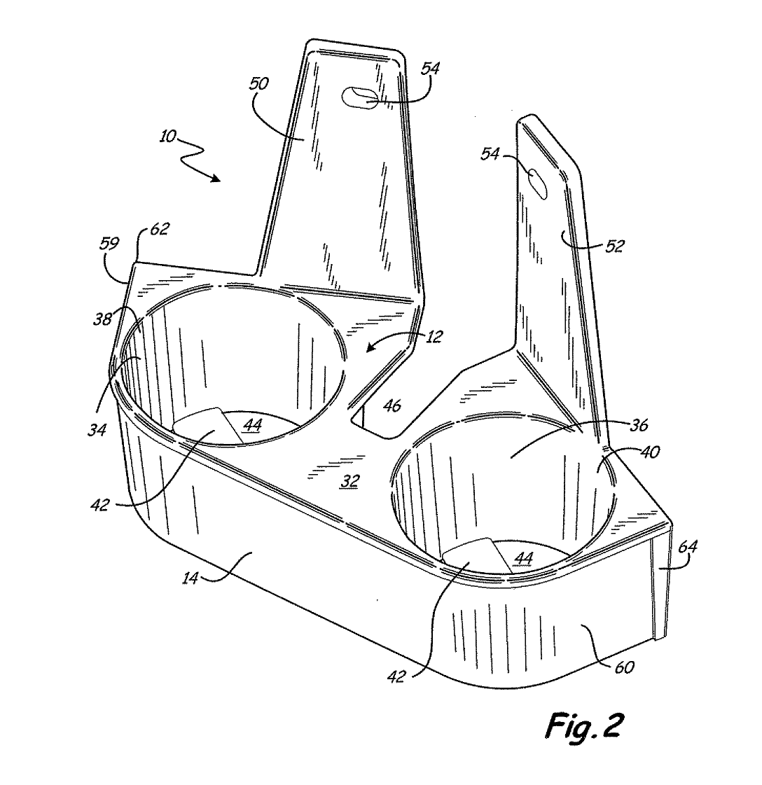

FIG. 2 is a front perspective view of the cup holder 10 of FIG. 1. The main body 12 of the cup holder 10 includes a flat top surface 32 having left and right openings 38, 40 to accommodate left and right receptacles 34, 36, respectively. The left and right receptacles 34, 36 extend downwardly from the top surface 32 and each is sized to accept a beverage container. The receptacles 34, 36 have a generally cylindrical sidewall and a bottom wall 42. In the illustrated embodiment, bottom wall 42 has cut out portions 44 to allow liquid that is inadvertently spilled within the receptacles 34, 36 to drain. It is contemplated that cut out portions 44 may have different shapes, spacings and sizes. Moreover, while a cylindrical shaped receptacle is shown, other configurations are also contemplated, including but not limited to a frusto-conical shaped receptacle. While a two-receptacle cup holder is shown, a cup holder with one, three or more receptacles is also contemplated.

In an exemplary embodiment, cup holder 10 also includes a slot 46 in the top surface 32 for accepting and surrounding a back portion of a seat arm standard 13 (shown in FIGS. 1 and 4). The disclosed structure of cup holder 10 facilitates the attachment of cup holder 10 to seat backs 22, 24 such that the front wall 14 of the cup holder 10 is positioned behind plane 16, while maximizing the beverage holding capacity of receptacles 34, 36. Slot 46 is used for seat standard constructions where the back of the standard 13 extends behind the seat backs 22, 24. If the back end of the standard 13 is even with or terminates in front of the back surface of the seat backs 22, 24, then slot 46 is not needed.

Cup holder 10 includes an attachment portion for attaching main body 12 at the juncture of two adjacent seat backs 22, 24. In some embodiments, the attachment portion mounts cup holder 10 on a seat standard. In other embodiments, the attachment portion mounts cup holder 10 directly onto the seat backs 22, 24. In an exemplary embodiment, the attachment portion includes left and right flanges 50, 52 extending upwardly from the top surface 32 on opposite sides of the slot 46. The left and right flanges 50, 52 are angled at mirror image angles to each other to follow the contours of the arcuate back surfaces of the two adjacent seat backs 22, 24.

For installation, left and right flanges 50, 52 are positioned proximate arcuate portions of the left and right seat backs 22, 24 at a juncture of the seat backs (See FIG. 1). The left and right flanges 50, 52 include apertures 54 for securing the cup holder 10 to the seat backs 22, 24. The use of upwardly extending flanges 50, 52 allows for easy access by an installer to the attachment mechanism of cup holder 10. Moreover, use of upwardly extending flanges 50, 52 leads to a very stable attachment that is not prone to detachment from regular use. While two flanges 50, 52 are shown, one, three or more flanges can be utilized to attach the cup holder to the seat back.

In the illustrated embodiment, substantially vertical side walls 59, 60 are connected with the front wall 14, which is also substantially vertical. Ends 62, 64 of the side walls 59, 60 are positioned proximate the seat backs 22, 24 to provide a continuous, smooth surface. Such continuity prevents accidental engagement of event goers with the cup holder 10 that could detrimentally effect the connection of the cup holder 10 to the seat backs 22, 24 or spill beverages from containers positioned within the receptacles 34, 36. Moreover, such a structure eases housekeeping requirements by providing smooth, easily cleaned surfaces.

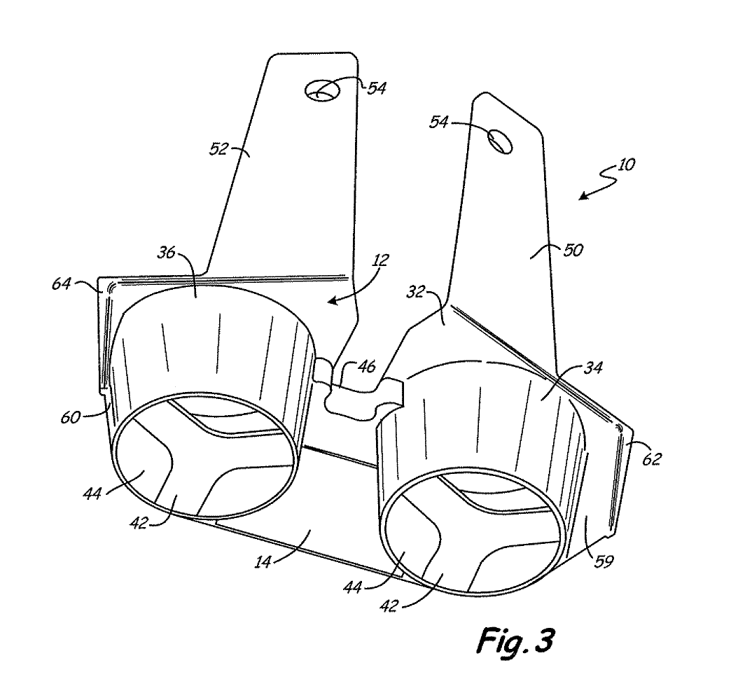

FIG. 3 is a rear perspective view of the cup holder of FIG. 1. As shown in the illustrated embodiment, a portion of front wall 14 and side walls 59, 60 is integral with receptacles 34, 36. Moreover, aside from flanges 50, 52 and ends 62, 64, there is substantially no back wall on cup holder 10. These structural features allow for materials savings, stability, easy maintenance, and maximization of cup holding capacity in a limited amount of space. The cup holder 10 is typically constructed from a durable polymeric material such as polyethylene. The cup holder 10 is typically formed through a molding process such that the cup holder 10 is of a unitary or monolithic construction.

FIG. 4 is a front perspective view of the cup holder 10 of FIG. 1 attached to adjacent seat backs 22, 24. As shown, cup holder 10 can be attached by screws inserted through the apertures 54 into the seat backs 22, 24 or alternatively by utilizing bolts 56 extending from the seat backs 22, 24 through the apertures 54. A nut 58 threadably engages to the threaded bolt 56 to secure the cup holder 10 to the adjacent seat backs 22, 24. Other attachment means and methods will be evident to those of skill in the art.

A recommended installation will take into account any clearance required by pivoting arm rest 6. Accordingly, cup holder 10 is preferably installed low enough with respect to arm standard 13 to prevent interference of cup holder with the pivoting operation of arm rest 6. Moreover, a spacing between left and right receptacles 34, 36 is chosen so that in a case where arm rest 6 pivots into a position between beverage containers 28, it does not cause dislodgement of beverage containers 28.

Although the present disclosure has been described with reference to preferred embodiments, workers skilled in the art will recognize that changes may be made in form and detail without departing from the spirit and scope of the invention.

What is claimed is:

1. A cup holder for installation at a juncture of two adjacent seat backs, wherein each of the seat backs has an arcuate back surface having a most rearward point, an intersection of the most rearward points of the two adjacent seat backs defining a plane, the cup holder comprising:
a main body comprising a receptacle for holding a beverage container, the main body having an installed depth dimension, the installed depth dimension being within a space defined by the adjacent seat backs and the plane; and
an attachment portion for attaching the main body at the juncture of two adjacent seat backs.

2. The cup holder of claim 1 wherein the attachment portion is configured for installation on a seat back.

3. The cup holder of claim 2 wherein the attachment portion comprises a flange extending from the main body.

4. The cup holder of claim 3 wherein the flange comprises an aperture.

5. The cup holder of claim 2 wherein the attachment portion comprises first and second flanges extending from the main body, wherein the first and second flanges are angled to follow contours of the arcuate back surfaces of the two adjacent seat backs.

6. The cup holder of claim 1, wherein the main body comprises a front wall.

7. The cup holder of claim 6, wherein the main body further comprises left and right side walls.

8. The cup holder of claim 7, wherein at least a portion of the receptacle is integral with at least a portion of the front wall and at least a portion of one of the side walls.

9. The cup holder of claim 1, wherein a juncture of two adjacent seat backs includes an arm standard, the main body of the cup holder comprising a slot configured to surround the arm standard.

10. The cup holder of claim 1 wherein the receptacle comprises a cylindrical side wall and a bottom wall.

11. The cup holder of claim 1 further comprising a second receptacle for holding a second beverage container.

12. The cup holder of claim 10 wherein the main body further comprises a top surface extending between the first and second receptacles.

13. The cup holder of claim 10 wherein the bottom wall further comprises a cut-out portion.
